(19) United States
(12) Patent Application Publication
(10) Pub. No.: US 2023/0031088 A1
(43) Pub. Date: Feb. 2, 2023

(54) HOLE FORMING DEVICE AND MACHINE UNIT THEREOF

(71) Applicant: VERO VERIA COPRORATION, New Taipei City (TW)

(72) Inventor: Chien-Teh HUANG, New Taipei City (TW)

(73) Assignee: VERO VERIA COPRORATION, New Taipei City (TW)

(21) Appl. No.: 17/560,955

(22) Filed: Dec. 23, 2021

(30) Foreign Application Priority Data
Jul. 27, 2021 (TW) 110127445
Jul. 27, 2021 (TW) 110208790

(51) Int. Cl. B23B 39/10

(52) U.S. Cl. CPC B23B 39/10

(57) ABSTRACT

A hole forming device is provided and includes a base platform with a machining area and at least one hole forming component displaceably disposed on the machining area for performing a hole forming machining on a target object, thereby speeding up the production, improving the production efficiency and reducing the labor cost.

### BACKGROUND

### 1. Technical Field

The present disclosure relates to machine tools for production lines, and more particularly, to a hole forming device and machine unit thereof capable of performing a hole forming machining on a target object.

### 2. Description of Related Art

Nowadays, elevated floor devices are widely applied in anti-static machine rooms or clean rooms. To prepare elevated floors by die casting of aluminum alloy, five main processes need to be performed, which include moldmaking, aluminum melting, die casting, molding and trimming. However, during the molding process, many buffs occur on the surface and bottom of the elevated floors, which not only adversely affect tight attachment between the elevated floors and between the elevated floors and a platform frame, but also are not conducive to installation and bring some safety concerns for workers.

Conventionally, after the molding process, holes are drilled manually in four foot bases of the elevated floor, which results in a low production efficiency and is both labor and time consuming for each machining.

Therefore, how to overcome the above-described drawbacks of the prior art has become an urgent issue in the art.

### SUMMARY

In view of the above-described drawbacks of the prior art, the present disclosure provides a machine unit, which comprises: at least one hole forming component having a tool body and a drilling tool disposed at an end of the tool body for performing a hole forming machining on a target object; and at least one motor integrated with the drilling tool in a linear manner for actuating the hole forming component to lift or descend and rotate the hole forming component simultaneously.

In the aforementioned machine unit, the drilling tool is a step drill.

The present disclosure further provides a hole forming device, which comprises: the aforementioned machine unit, wherein the target object has a first surface and a second surface opposite to the first surface, and wherein the second surface has four corners having four foot bases; a base platform having a working surface defined with a machining area and a discharging area, wherein the hole forming component is displaceably disposed on the machining area to perform the hole forming machining on the foot bases of the target object, thereby completing drilling of counterbored holes required at the foot bases of the target object; a positioning structure disposed on the machining area of the base platform for limiting the target object in the machining area; and a fastening structure configured corresponding to the positioning structure and abutting against the target object on the base platform.

In the aforementioned hole forming device, the present disclosure further comprises a detector disposed at an edge of the machining area for determining a position of the target object in the machining area.

In the aforementioned hole forming device, the positioning structure further comprises a plurality of fastening portions each having a buffer member disposed on a top end thereof.

In the aforementioned hole forming device, the hole forming component is disposed on the machining area via a support structure.

In the aforementioned hole forming device, the machining area and the discharging area are non-coplanar.

In the aforementioned hole forming device, the positioning structure comprises a pressing member disposed over the machining area and an abutting member disposed at an edge of the machining area.

In the aforementioned hole forming device, the motor is exposed from a covering portion of the support structure, and foot portions of the support structure are fastened on the base platform.

In the aforementioned hole forming device, the present disclosure further comprises an actuating structure disposed on the machining area in a direction corresponding to the discharging area, wherein the target object in the machining area is pushed by the actuating structure to displace to the discharging area.

In summary, in the hole forming device and the machine unit thereof according to the present disclosure, the hole forming component is actuated by the servo motor so as to perform a hole drilling machining on foot bases of a target object such as an elevated floor, thus speeding up the production, improving the production efficiency and reducing the labor cost.

### BRIEF DESCRIPTION OF DRAWINGS

FIG. 1A-1 is a schematic front perspective view of a hole forming device applied to a machining apparatus according to the present disclosure.

FIG. 1A-2 is a schematic rear perspective view of the machining apparatus of FIG. 1A-1.

FIG. 1A-3 is a schematic perspective view of a transport device of the machining apparatus of FIG. 1A-1.

FIG. 1B is a schematic partially-enlarged perspective view of position B of FIG. 1A-3.

FIG. 1C-1 is a schematic top perspective view of a target object to be processed by the machining apparatus of FIG. 1A-1.

FIG. 1C-2 is a schematic bottom perspective view of FIG. 1C-1.

FIG. 1C-3 is a schematic side plan view of FIG. 1C-1.

FIG. 1D is a schematic side plan view of the target object that is already processed by the machining apparatus of FIG. 1A-1.

FIG. 2A-1 is a schematic perspective view of a hole forming device according to the present disclosure.

FIG. 2A-2 is a schematic partially exploded perspective view of FIG. 2A-1.

FIG. 2A-3 is a schematic partial perspective view of FIG. 2A-1.

FIG. 2B is a schematic partial top view of FIG. 2A-1.

FIG. 2C is a schematic partial front view of FIG. 2A-1.

FIG. 2D is schematic partial perspective view of FIG. 2A-3.

FIG. 3A-1 is a schematic partial perspective view of the hole forming device of FIG. 2A-1 in use.

FIG. 3A-2 is a schematic top view of FIG. 3A-1.

FIG. 3B is a schematic partial perspective view of the hole forming device of FIG. 2A-1 after completion of a hole drilling machining.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “up,” “down,” “front,” “rear,” “left,” “right,” “a,” etc. are merely for illustrative purposes and should not be construed to limit the scope of the present disclosure.

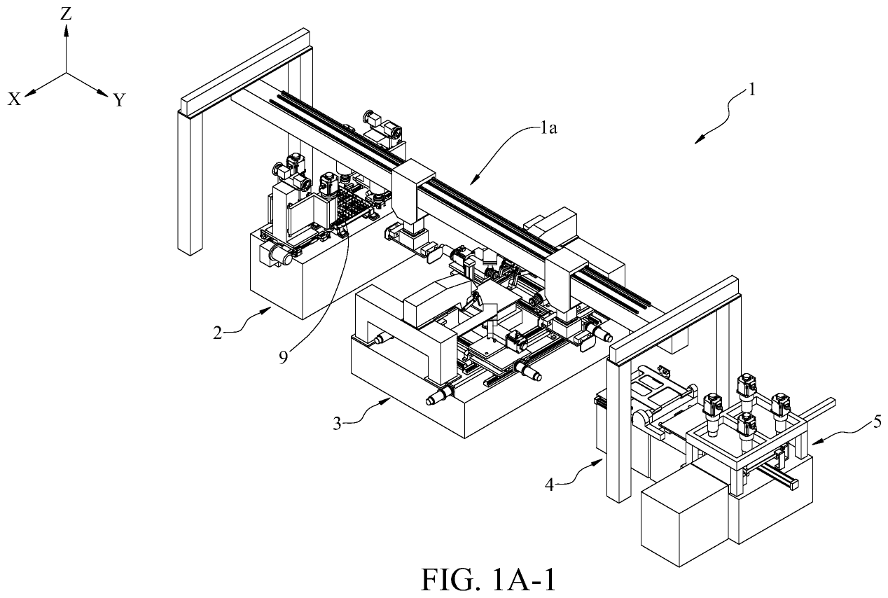

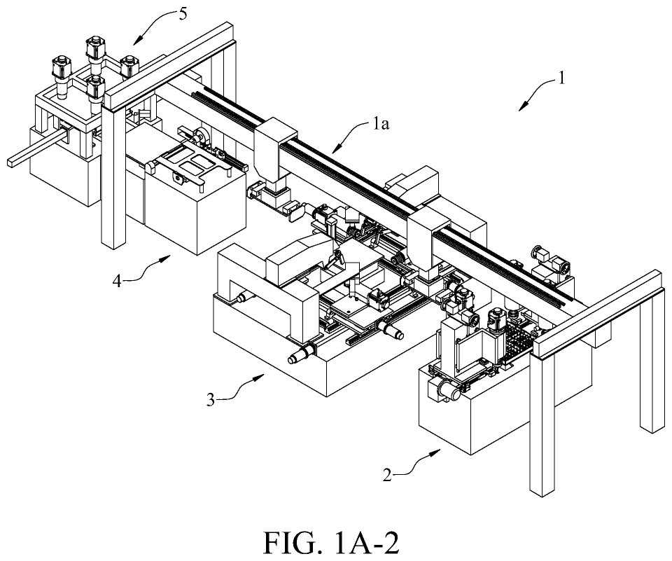

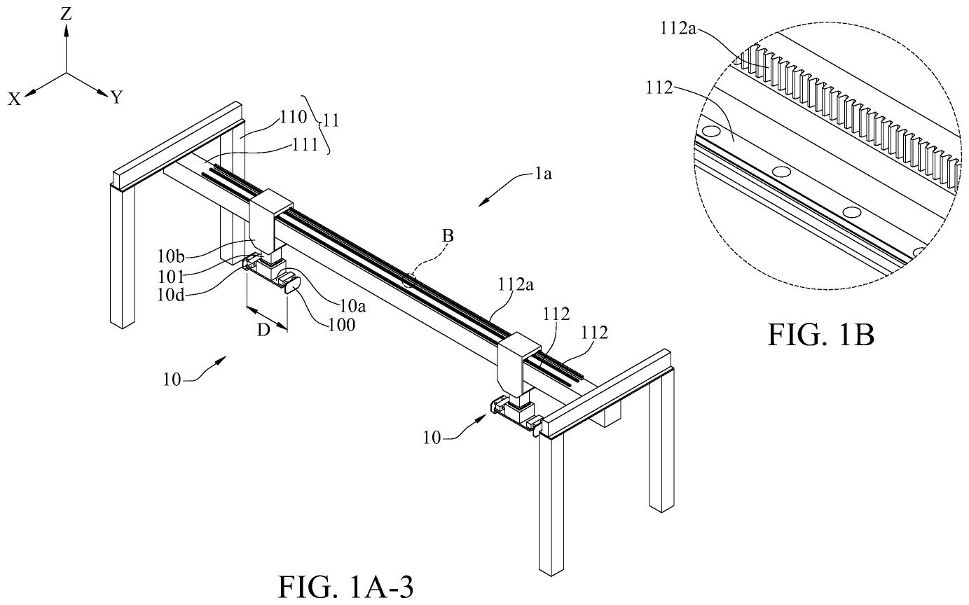

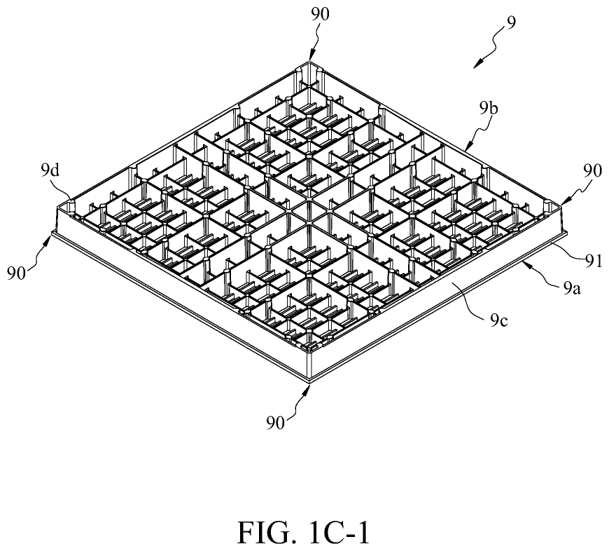

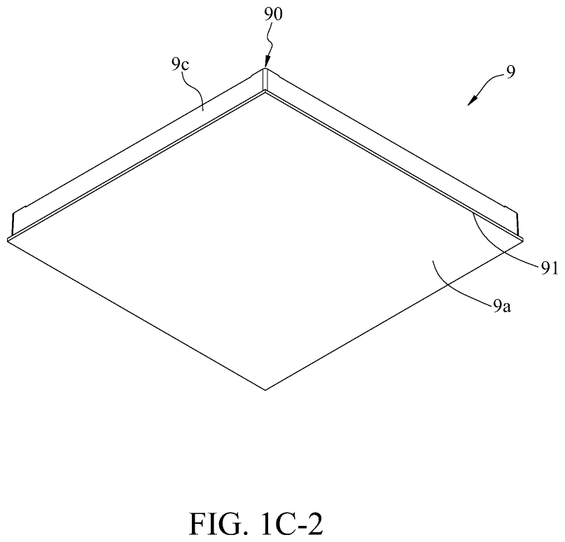

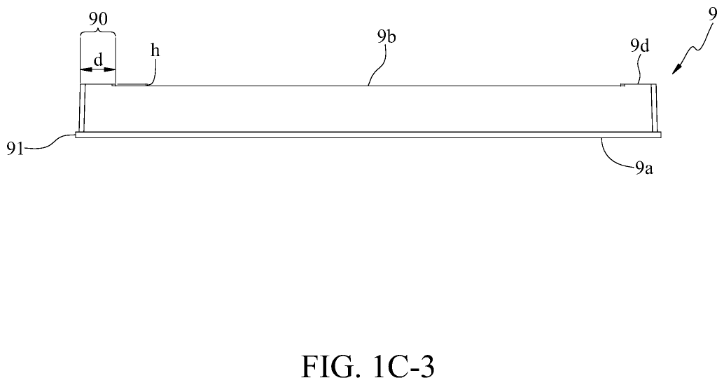

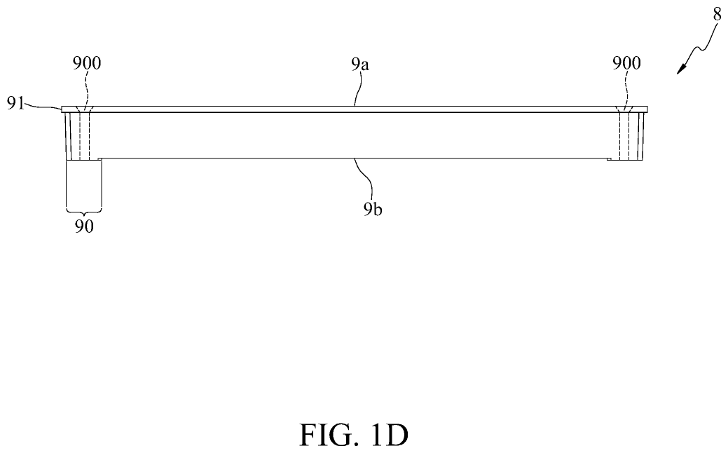

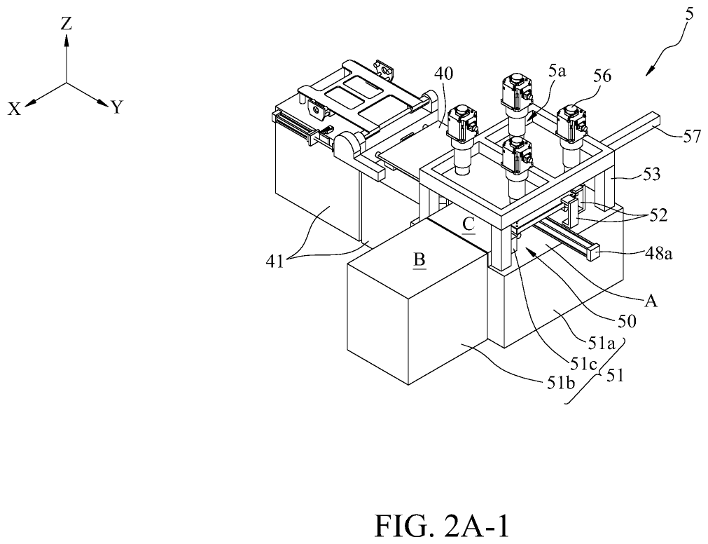

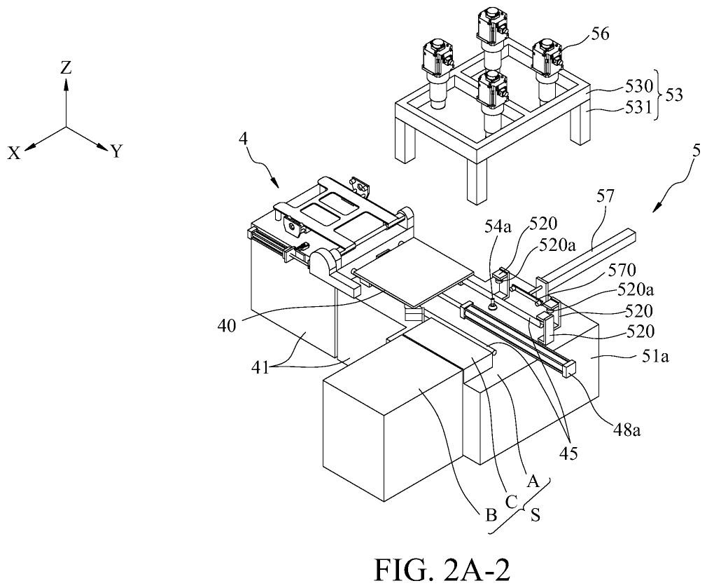

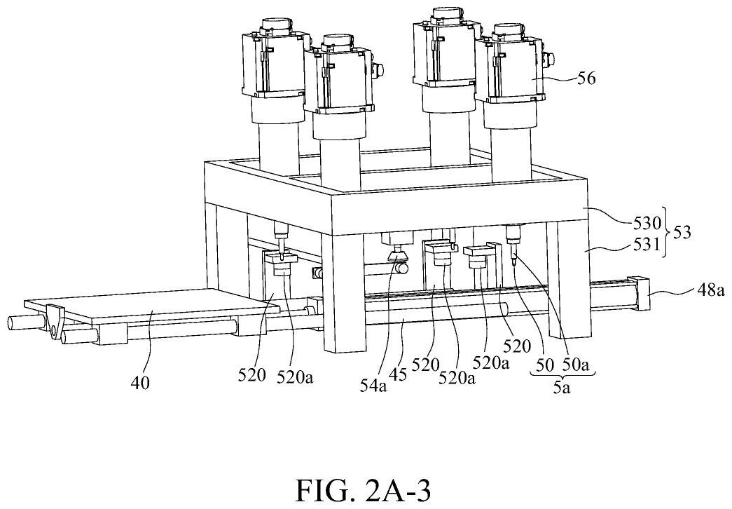

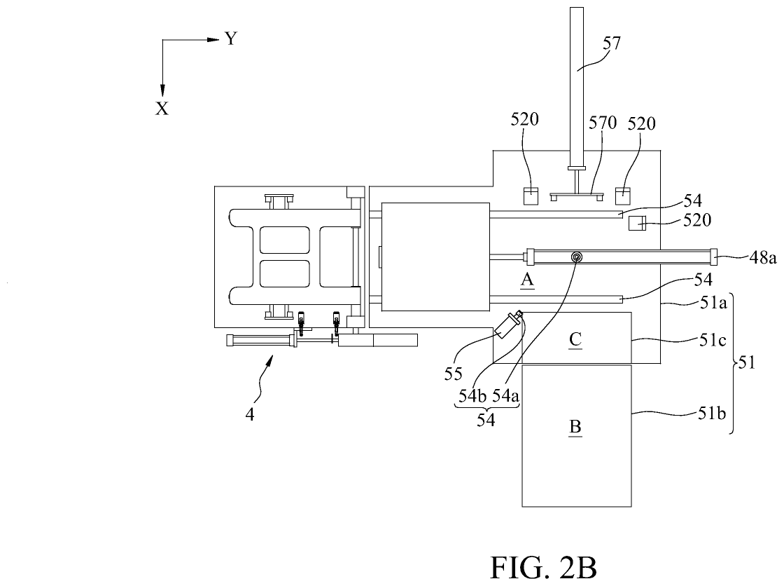

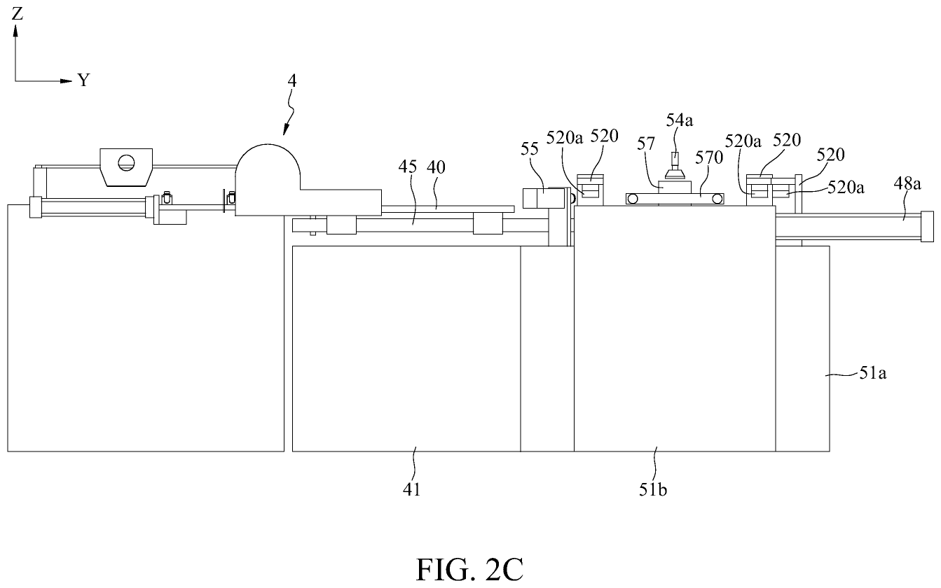

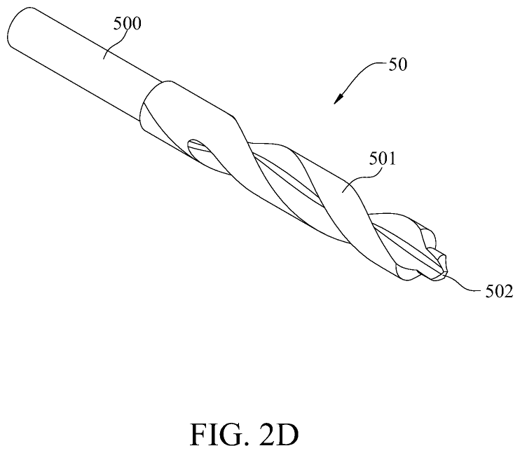

FIGS. 1A-1 and 1A-2 are schematic perspective views of a hole forming device 5 applied to a machining apparatus 1 according to the present disclosure. Referring to FIGS. 1A-1 and 1A-2, the machining apparatus 1 includes a transport device 1a, a height milling device 2, an edge milling device 3, a flipping device 4 and a hole forming device 5.

In an embodiment, for the machining apparatus 1 and for purpose of illustration, the direction of the production line is defined as a left or right direction (e.g., an arrow direction Y), a direction perpendicular to the production line is defined as a front or rear direction (e.g., an arrow direction X), and the height direction along the machining apparatus 1 is defined as a top or bottom direction (e.g., an arrow direction Z). It should be understood that the aforementioned orientations are used to illustrate the arrangement of the embodiment, and the present disclosure is not limited thereto.

The transport device 1a is used to transport (e.g., grip) a target object 9 to a required machining position of the production line. To facilitate placing of the target object 9 on the height milling device 2, the edge milling device 3, the flipping device 4 and/or the hole forming device 5, the transport device 1a is disposed over the height milling device 2, the edge milling device 3, the flipping device 4 and the hole forming device 5.

In an embodiment, referring to FIG. 1A-3, the transport device 1a includes at least a picking and placing component 10 for picking and placing the target object 9, and a support component 11 for displaceably arranging the picking and placing component 10 and allowing the picking and placing component 10 to displace so as to move the target object 9. For example, the support component 11 has a frame structure, which has two groups of door-shaped rod frames 110 (e.g., opposite to each other) vertically disposed on a base surface (e.g., floor) and a beam 111 disposed across the rod frames 110. The beam 111 is positioned over the height milling device 2, the edge milling device 3 and the flipping device 4 to serve as a displacement path of the picking and placing component 10. It should be understood that the support component 11 can be of various types and not limited to the above.

Further, the picking and placing component 10 includes a gripping portion 10a with a holding member 100 and a carrying portion 10b for arranging the gripping portion 10a. For example, the width D of the holding member 100 of the gripping portion 10a can be adjusted according to the requirement so as to grip the target object 9 having a different width. A hydraulic or pneumatic cylinder (serving as a power source 10d) can be used to control the distance between the two gripping portions 10a so as to grip or loosen the target object 9. The carrying portion 10b is a movable frame, which is vertically disposed on the beam 111 (or a position limiter 112) and pivotally connected to a gear (not shown). The gear (not shown) is engaged with a rack 112a (as shown in FIG. 1B). A driving force causes the gear to move linearly on the rack 112a such that the picking and placing component 10 can move linearly back and forth in the arrow direction Y with a sliding base (e.g., the carrying portion 10b) and the sliding rail component (e.g., the position limiter 112 and the rack 112a and gear on the position limiter 112). For instance, the plurality of power sources 10d (e.g., the pneumatic or hydraulic cylinder of FIG. 1A-3) drive the gripping portion 10a to bring the holding member 100 to extend outward or retract inward (in the arrow direction Y), thus producing a loosening or holding action. Further, a retractable structure 101 connected to the gripping portion 10a is disposed on the bottom of the carrying portion 10b so as to lift or descend the gripping portion 10a. A motor (not shown) can be disposed over the carrying portion 10b so as to drive the carrying portion 10b to displace, thereby driving the gear to move linearly on the rack 112a.

Furthermore, the number of the picking and placing component 10 can be set according to needs. For example, the picking and placing components 10 are respectively arranged corresponding to machining positions of the height milling device 2, the edge milling device 3 and the flipping device 4 (as such, at least two picking and placing components 10 are arranged). For instance, one picking and placing component 10 is arranged between the height milling device 2 and the edge milling device 3, and the other picking and placing component 10 is arranged between the edge milling device 3 and the flipping device 4. If needed, a plurality of picking and placing components 10 can be added between the rod frames 110 and the height milling device 2 to serve as intermediate transferring components of the target object 9. As such, the target object 9 can be continuously picked and placed at each machining position so as to complete machining processes of the entire production line.

In addition, referring to FIGS. 1C-1, 1C-2 and 1C-3, the target object 9 is an elevated floor, which has a first surface 9a (e.g., a floor surface), a second surface 9b (e.g., a bottom end) opposite to the first surface 9a, and a side surface 9c adjacent to and connecting the first surface 9a and the second surface 9b. For example, the target object 9 is a substantially rectangular body (e.g., a square plate), the bottom of the target object 9 (e.g., the second surface 9b, which is the bottom of the elevated floor) has a honeycomb shape, and four corners of the second surface 9b of the target object 9 have four foot bases 90. Referring to FIG. 1D, holes 900 can be formed in the four foot bases 90 so as to fasten the four foot bases 90 on support legs by using screws (the support legs are used by the elevated floor). For instance, end surfaces 9d of the foot bases 90 slightly protrude from the second surface 9b of the target object 9 (with a height difference h, as shown in FIG. 1C-3), and a flange 91 is formed at an edge of the first surface 9a and protrudes from the side surface 9c. The flange 91 is the four edges of the elevated floor to be processed by the edge milling device 3. Since the target object 9 of the embodiment is an elevated floor, it is referred to as elevated floor hereinafter.

FIGS. 2A-1 to 2D, 2A-2 and 2A-3 are schematic views of the hole forming device 5 according to the present disclosure. In an embodiment, the hole forming device 5 is disposed at the latest machining stage of the entire production line and actuates in cooperation with the flipping device 4 so as to form at least a hole 900 (counterbored hole as shown in FIG. 1D) on the first surface 9a of the target object 9. For example, a hole drilling process is performed on the foot bases 90 of the elevated floor so as to form positioning holes of the elevated floor.

Referring to FIGS. 2A-1 to 2D, the hole forming device 5 has a hole forming component 5a for forming four holes 900 of the target object 9. The hole forming component 5a includes at least a servo motor 56 (e.g., the servo motor 56 may be used as a motor), a tool body 50a, a drilling tool 50 disposed at the bottom of the tool body 50a, and a support structure 53. The hole forming component 5a is disposed on the support structure 53. The target object 9 is fastened on a positioning structure 52 of a base platform 51, and the hole forming component 5a drills holes in the target object 9 on the base platform 51.

The base platform 51 is a machine-tool working platform, which is a substantially rectangular body and has a working surface S of a rectangular planar shape. A machining area A and a discharging area B are defined on the working surface S.

In an embodiment, the base platform 51 can be provided with electromechanical components such as motors, wires, or other related machine units that are required by the production line, and the present disclosure is not limited as such.

Further, the base platform 51 is connected to a platform 41 of the flipping device 4, and the machining area A and the platform 41 are coplanar. A guiding rail 45 on the platform 41 can extend into the machining area A of the base platform 51. For example, the path direction of feeding (from the platform 41 to the machining area A) or the guiding rail 45 is perpendicular to the path direction of discharging (from the machining area A to the discharging area B). For instance, a feeding plate 40 is engaged on the guiding rail 45. As such, the feeding plate 40 can displace along the guiding rail 45 relative to the platform 41 via a pneumatic or hydraulic component (e.g., a power unit 48a) so as to transport the elevated floor to the machining area A.

Furthermore, the base platform 51 can include a first carrying base 51a and a second carrying base 51b. The machining area A is located on the first carrying base 51a, the discharging area B is located on the second carrying base 51, and the machining area A and the discharging area B are non-coplanar. For example, the height of the first carrying base 51a is lower than the height of the second carrying base 51b, and hence the height of the discharging area B is higher than the height of the machining area A. Further, a transferring base 51c is disposed on the machining area A of the first carrying base 51a and has a transferring area C coplanar with the discharging area B. For instance, the feeding plate 40 in the machining area A is substantially coplanar with the transferring area C (or the discharging area B).

The positioning structure 52 is disposed at an edge of the machining area A so as to position the target object 9 in the machining area A.

In an embodiment, the positioning structure 52 includes a plurality of fastening portions 520 each made of an L-shaped or U-shaped plate and disposed at an edge of the feeding plate 40 so as to limit the displacement of the feeding plate 40 and prevent the feeding plate 40 and the target object 9 on the feeding plate 40 from deviating in the machining area A. For instance, according to the path direction of feeding (from the platform 41 to the machining area A) or the guiding rail 45, the fastening portions 520 are disposed at the end of the feeding path, for example, rear and right sides of the machining area A, thereby limiting the displacement of the feeding plate 40. For example, a buffer member 520a, such as a runner (e.g., rotating wheel), a bearing or the like, is disposed on a top end of each of the fastening portions 520 so as to contact the target object 9 in a smooth sliding manner. Therefore, the feeding plate 40 and the target object 9 thereon can smoothly enter the machining area A (e.g., without being jammed) with reduced friction.

Moreover, at least a detector 55 is disposed at an edge of the machining area A so as to determine whether the position of the target object 9 is correct. For example, the detector 55 is an optical unit (e.g., using an infrared positioning method) or a camera, which is disposed at one of the corners of the machining area A. For instance, the detector 55 is disposed at another side opposite to the fastening portions 520 (i.e., in a diagonal manner) so as to completely confirm that the position of the feeding plate 40 has been positioned.

The support structure 53 is a frame body, which corresponds to the range of the machining area A and covers over the machining area A.

In an embodiment, the support structure 53 has a rectangular covering portion 530 and a plurality of foot portions 531 vertically disposed on a bottom side of the covering portion 530. As such, the foot portions 531 are vertically disposed at corners of the machining area A, and the covering portion 530 substantially covers over the machining area A.

Further, the fastening structure 54 abuts against the target object 9. For example, the fastening structure 54 includes at least a pressing member 54a, such as a physically pressing head or a vacuum adsorption head, disposed on a lower side of the covering portion 530 of the support structure 53 so as to press the target object 9. For instance, the fastening structure 54 can be driven by a pneumatic or hydraulic component (not shown) to press the target object 9. Therefore, after the target object 9 is placed on the machining area A, the first surface 9a of the target object 9 can be tightly fastened by the pressing member 54a so as to prevent the target object 9 from deviating during a hole forming process.

Furthermore, the fastening structure 54 can cooperate with the detector 55 and fasten the target object 9 after the feeding plate 40 is positioned. For example, the fastening structure 54 can have an abutting member 54b, such as a retractable rod structure, disposed at the detector 55. For instance, after the target object 9 is placed on the machining area A, the abutting member 54b protrudes from the corner abutting against the target object 9 to prevent the target object 9 from deviating during the hole forming process.

The hole forming component 5a is disposed on the support structure 53 and thus over the machining area A.

In an embodiment, the hole forming component 5a includes a tool body 50a and a drilling tool 50 disposed at a bottom end of the tool body 50a. For example, referring to FIG. 2D, the drilling tool 50 is a step drill, which is disposed at a corner of the support structure 53 for performing a hole drilling process on a foot base 90 of the elevated floor so as to form a counterbored hole (e.g., the hole 900 of FIG. 1D). For instance, one end of the drilling tool 50 has a mounting portion 500 mounted on the tool body 50a, and the other end of the drilling tool 50 has a twist-shaped acting portion 501 with a tip 502.

Further, the hole forming component 5a is disposed on the covering portion 530. For example, the hole forming component 5a is arranged corresponding to the corners of the covering portion 530, such that four hole forming components 5a are disposed on the covering portion 530, and the servo motors 56 are exposed from the covering portion 530.

Furthermore, at least a servo motor 56 can be disposed on the support structure 53 according to needs so as to actuate the drilling tool 50. For example, the servo motor 56 drives the hole forming component 5a to vertically lift or descend and rotate simultaneously, thereby performing a hole drilling process on the foot base 90 of the elevated floor so as to form a counterbored hole. For instance, the servo motor 56 and the hole forming component 5a form a machine unit, which performs a hole drilling process so as to simultaneously form counterbored holes required at the four foot bases 90 of the target object 8.

In addition, the servo motor 56 and the drilling tool 50 are integrated in a linear manner so as to reduce volume, and the servo motor 56 directly drives the drilling tool 50 to rotate, thus causing the hole forming component 5a on the base platform 51 to perform a hole drilling process on the target object 9. For example, the servo motor 56 may be used as a motor. Therefore, the present disclosure is characterized in that the servo motor 56 directly drives the drilling tool 50 to rotate, which not only reduces the volume of the hole forming component 5a, but also improves the machining precision and machining speed through digital control of rotation of the servo motor 56. The conventional motor driving of the prior art cannot achieve such an efficiency.

Further, the first carrying base 51a has an actuating structure 57 disposed on the machining area A in a direction corresponding to the discharging area B. The actuating structure 57 can push the side surface 9c of the target object 9 in the machining area A. As such, after the target object 9 is processed in the machining area A, the target object 9 can be displaced under force to the discharging area B. For example, the actuating structure 57 is a retractable rod structure, which has a rake-shaped pushing portion 570 at the front end thereof for stably pushing the side surface 9c of the target object 9 in the machining area A via a pneumatic or hydraulic component (not shown).

Referring to FIGS. 3A-1 and 3A-2, when the hole forming device 5 is used on the production line, the power unit 48a slidingly moves the feeding plate 40 along the guiding rail 45 to the machining area A of the base platform 51. The positioning structure 52 limits the position of the feeding plate 40, and the detector 55 further confirms the position of the target object on the feeding plate 40. Subsequently, the fastening structure 54 abuts against the first surface 9a and corner of the target object 9 on the feeding plate 40 (lowering the pressing member 54a and outwardly extending the abutting member 54b). Thereafter, a hole drilling operation is carried out by the acting portion 501 of the drilling tool 50 of the hole forming component 5a so as to form holes 900 in the foot bases 90, as shown in FIG. 1D.

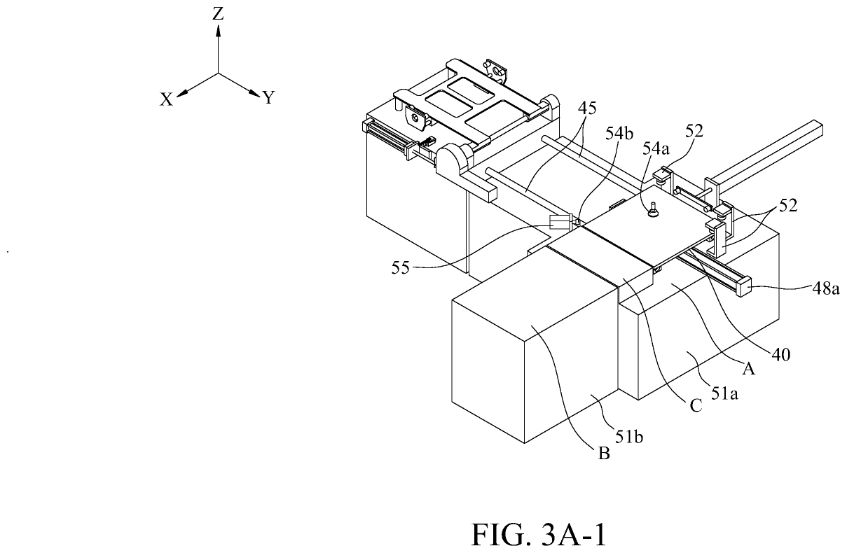

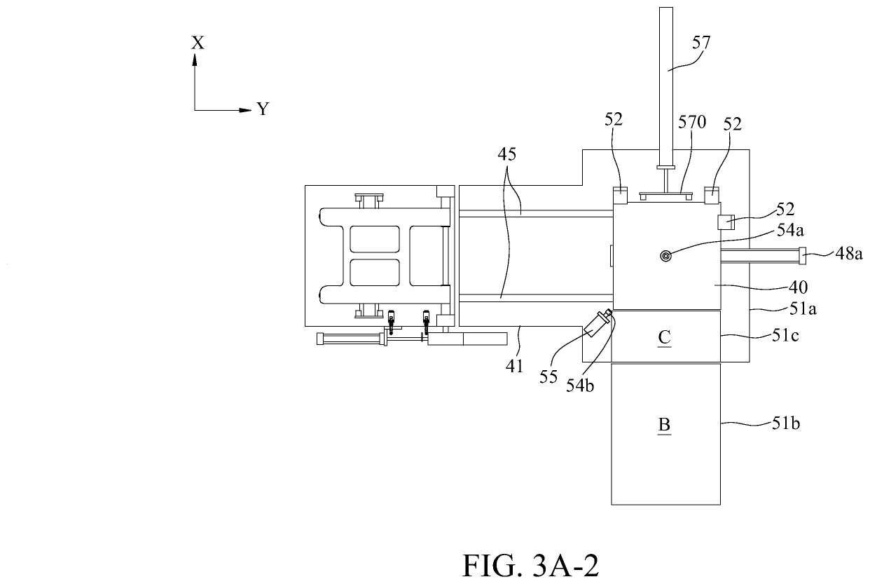

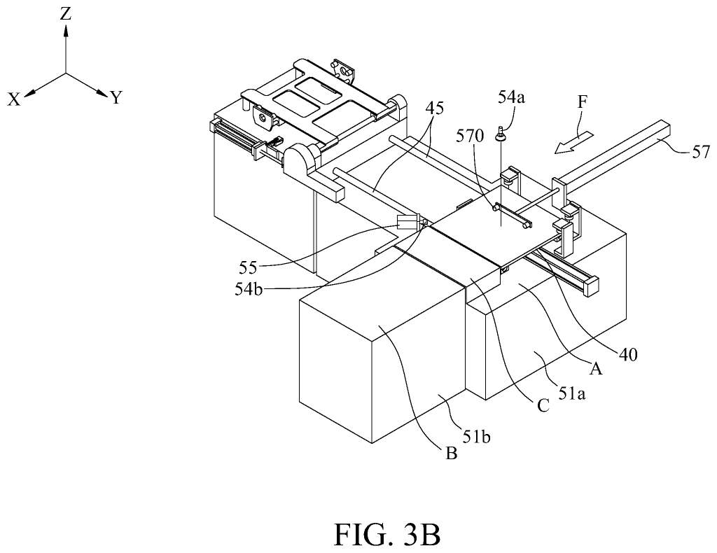

Referring to FIG. 3B, after the hole drilling operation is completed, the fastening structure 54 (lifting the pressing member 54a and retracting the abutting member 54b) is retracted, and the target object 8 that has finished the hole drilling machining is pushed forward by the actuating structure 57 (e.g., in a pushing direction F), as shown in FIG. 1D. Hence, the target object 8 on the feeding plate 40 is moved through the transferring area C to the discharging area B, thus completing the entire hole drilling machining of the elevated floor.

In summary, in the hole forming device 5 according to the present disclosure, the hole forming component 5a is actuated by the servo motor 56 so as to perform a hole forming machining on the foot bases 90 of the elevated floor, thereby speeding up the production, improving the production efficiency and reducing the labor cost.

The above-described descriptions of the detailed embodiments are to illustrate the implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. A machine unit, comprising:
at least one hole forming component having a tool body and a drilling tool disposed at an end of the tool body for performing a hole forming machining on a target object; and
at least one motor integrated with the drilling tool in a linear manner for actuating the hole forming component to lift or descend and rotate the hole forming component simultaneously.

2. The machine unit of claim 1, wherein the drilling tool is a step drill.

3. A hole forming device, comprising:
the machine unit of claim 1, wherein the target object has a first surface and a second surface opposite to the first surface, and wherein the second surface has four corners having four foot bases;
a base platform having a working surface defined with a machining area and a discharging area, wherein the hole forming component is displaceably disposed on the machining area to perform the hole forming machining on the foot bases of the target object, thereby completing drilling of counterbored holes required at the foot bases of the target object;
a positioning structure disposed on the machining area of the base platform for limiting the target object in the machining area; and
a fastening structure configured corresponding to the positioning structure and abutting against the target object on the base platform.

4. The hole forming device of claim 3, further comprising a detector disposed at an edge of the machining area for determining a position of the target object in the machining area.

5. The hole forming device of claim 3, wherein the positioning structure further comprises a plurality of fastening portions each having a buffer member disposed on a top end thereof.

6. The hole forming device of claim 3, wherein the hole forming component is disposed on the machining area via a support structure.

7. The hole forming device of claim 3, wherein the machining area and the discharging area are non-coplanar.

8. The hole forming device of claim 3, wherein the positioning structure comprises a pressing member disposed over the machining area and an abutting member disposed at an edge of the machining area.

9. The hole forming device of claim 3, wherein the motor is exposed from a covering portion of the support structure, and foot portions of the support structure are fastened on the base platform.

10. The hole forming device of claim 3, further comprising an actuating structure disposed on the machining area in a direction corresponding to the discharging area, wherein the target object in the machining area is pushed by the actuating structure to displace to the discharging area.
